(19) United States
(12) Patent Application Publication
(10) Pub. No.: US 2016/0093004 A1
(43) Pub. Date: Mar. 31, 2016

(54) METHOD, TERMINAL, AND SERVER FOR PROVIDING PERSONALIZED FOOD INFORMATION FOR FOOD SAFETY

(71) Applicant: ELECTRONICS AND TELECOMMUNICATIONS RESEARCH INSTITUTE, Daejeon (KR)

(72) Inventors: Han-Seung KOO, Daejeon (KR); Sung-Hei KIM, Daejeon (KR); Jae-Hong MIN, Daejeon (KR); Ju-Young PARK, Daejeon (KR)

(21) Appl. No.: 14/795,006

(22) Filed: Jul. 9, 2015

(30) Foreign Application Priority Data
Sep. 25, 2014 (KR) 10-2014-0128653
Mar. 27, 2015 (KR) 10-2015-0043115

(51) Int. Cl. G06Q 50/12; G06Q 30/00

(52) U.S. Cl. CPC G06Q 50/12; G06Q 30/018

(57) ABSTRACT

A method, terminal and server for providing personalized food information for food safety are disclosed herein. The server includes a communication unit, and a processing unit. The communication unit receives a request for knowledge information related to the intake of a food of a user from a terminal and to send notification data to the terminal. The request includes the food identifier of the food and the personal information of the user. The processing unit generates the notification data, including the knowledge information, using food information, indicated by the food identifier, and the personal information.

### CROSS-REFERENCE TO RELATED APPLICATION

This application claims the benefit of Korean Patent Application Nos. 10-2014-0128653 and 10-2015-0043115, filed Sep. 25, 2014 and Mar. 27, 2015, respectively, which are hereby incorporated by reference herein in their entirety.

### BACKGROUND

1. Technical Field

Embodiments of the present invention relate generally to a method and apparatus for providing information and, more particularly, to a method, terminal and server for providing personalized food information for food safety.

2. Description of the Related Art

For a healthy life, it is very important to select safe foods and food materials. However, the same food may be either good or harmful for some people depending upon the health status of a person who ingests food. An example for which food may be dangerous for a person is an allergy. An allergy is a representative example for which food is dangerous for people, and is also an example of how dangerous food can be. In particular, it is difficult for an ordinary person to determine whether there is an ingredient that causes an allergic reaction within him or her based on only the outward appearance of a processed food or a food provided in a food store.

Additionally, the amount of food intake may be required to be controlled depending on a person. For example, a person who diets may control a daily caloric intake in order to reduce weight, and may calculate and track an approximate caloric content of food that is ingested. Furthermore, some people may require a specific ingredient or nutritive substance within food. For example, an osteoporosis sufferer must ingest a specific amount of calcium or more per day. However, it is difficult for an osteoporosis sufferer to check the amount of calcium in food, and it is very difficult for an osteoporosis sufferer to check all information about foods which hinder the absorption of calcium, such as a carbonated drink.

### SUMMARY

At least some embodiments of the present invention are directed to the provision of a method and apparatus for generating knowledge information related to the intake of food by using food information and the personal information of a user.

At least some embodiments of the present invention are directed to the provision of a method and apparatus for providing an early warning for food to be ingested by a user.

In accordance with an aspect of the present invention, there is provided a method of providing food information, the method including: by a server: receiving a request for knowledge information related to the intake of a food of a user of a terminal from the terminal, wherein the request comprises the food identifier of the food and the personal information of the user; generating notification data, including the knowledge information, using food information, indicated by the food identifier, and the personal information; and sending the notification data to the terminal.

The knowledge information may be indicative of a problem with the intake of the food of the user.

The knowledge information may be indicative of whether the food includes an ingredient that causes an allergic reaction within the user indicated by the personal information.

The knowledge information may be indicative of the achievement status of an intake target of the ingredient of the food related to the personal information.

The knowledge information may be indicative of whether an attribute of the food complies with the taste of the user indicated by the personal information.

The attribute may include the place of origin of the food.

The server may search a knowledge base of the server for the knowledge information corresponding to the food information and the personal information using the food information and the personal information.

The server may generate the knowledge information through reasoning based on a food history of the food and the personal information.

The food history may include at least one of a production history of the food, a distribution history of the food, and a sales history of the food.

The server may convert the generated knowledge information into a form that is able to be added to the knowledge base, and may add the converted knowledge information to the knowledge base.

The personal information may include a search condition indicative of information that is related to the food and that is required by the user.

The search condition may be generated by converting a personal condition, including content that infringes upon the privacy of the user, into content that does not violate privacy.

The method may further include receiving the knowledge information from food information storage managed by a provider of the food.

In accordance with another aspect of the present invention, there is provided a server, including: a communication unit configured to receive a request for knowledge information related to the intake of a food of a user of a terminal from the terminal and to send notification data to the terminal, wherein the request includes the food identifier of the food and the personal information of the user; and a processing unit configured to generate the notification data, including the knowledge information, using food information, indicated by the food identifier, and the personal information.

In accordance with still another aspect of the present invention, there is provided a terminal, including: a communication unit configured to send a request for knowledge information related to the intake of a food of a user of the terminal to a server and to receive notification data, including the knowledge information, from the server, wherein the request includes the food identifier of the food and the personal information of the user; and an output unit configured to output a message indicative of the knowledge information; wherein the knowledge information is generated based on food information, indicated by the food identifier, and the personal information.

The terminal may further include a processing unit configured to convert the personal information into a search condition related to an attribute of the food if the personal information includes content that infringes upon privacy.

If the personal information is indicative of a disease of the user, the processing unit may specify a food material or ingredient related to the disease, and may convert the personal information into a search condition that queries whether the food indicated by the food identifier includes the specific food material or ingredient.

The processing unit may convert the knowledge information into content related to the privacy of the user.

If the personal information is indicative of an intake target of a specific ingredient, the processing unit may convert the personal information into a search condition that queries the amount of the ingredient.

The terminal may further include a sensor configured to recognize the food identifier.

### BRIEF DESCRIPTION OF THE DRAWINGS

The above and other objects, features and advantages of the present invention will be more clearly understood from the following detailed description taken in conjunction with the accompanying drawings, in which:

FIG. 1 illustrates a service for providing a personalized food information service according to an example;

FIG. 2 illustrates the configuration of a server according to an embodiment of the present invention;

FIG. 3 illustrates the configuration of a terminal according to an embodiment of the present invention;

FIG. 4 illustrates the function of the terminal according to an embodiment of the present invention;

FIG. 5 illustrates the function of the server according to an embodiment of the present invention;

FIG. 6 is a flowchart illustrating a method of providing personalized food information using a terminal according to an embodiment of the present invention;

FIG. 7 is a flowchart illustrating a method of providing personalized food information using a sever according to an embodiment;

FIG. 8 illustrates a personalized food information service for a user having an allergy according to an example;

FIG. 9 illustrates a personalized food information service for a user who prefers food from a specific place of origin according to an example;

FIG. 10 illustrates a personalized food information service for a user who has a diet target according to an example; and

FIG. 11 illustrates a computer system for performing the method of the aforementioned embodiments.

### DETAILED DESCRIPTION

Embodiments of the present invention will be described in detail below with reference to the accompanying drawings. It should be appreciated that these embodiments are different but are not necessarily exclusive.

The terms used in connection with these embodiments should be defined not simply by the names of the terms but by their meanings and the overall context of the present specification.

In these embodiments, the connection between two components or portions may include not only the direct connection therebetween but also the indirect connection therebetween. Throughout the drawings, the same reference numerals are used to designate the same or similar components or portions.

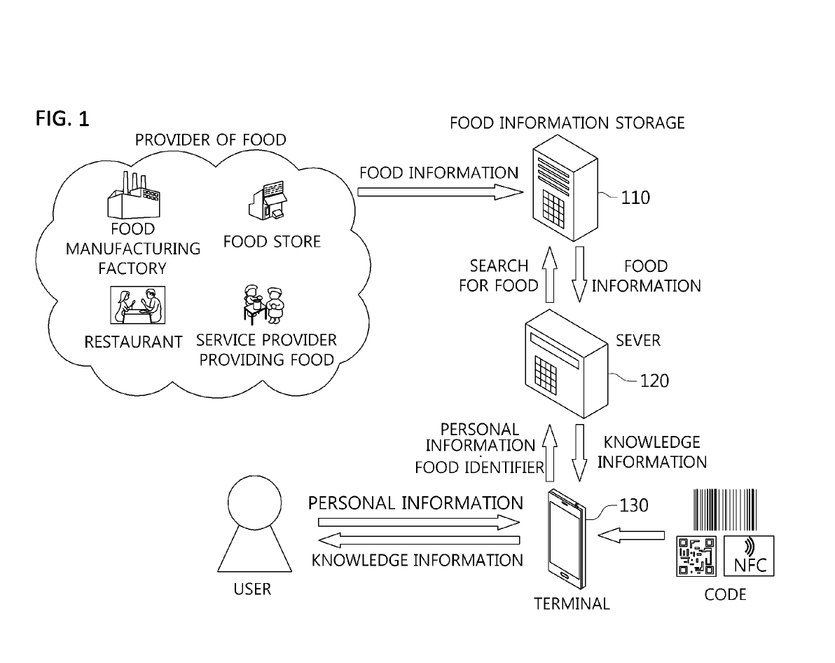

FIG. 1 illustrates a service for providing a personalized food information service according to an example.

A personalized food information service may be provided by food information storage 110, a server 120 configured to provide personalized food information, and a terminal 130.

Food may include all objects that may be ingested by people, such as a processed food, a cooked food, and a natural food. Furthermore, a food may include a food material, i.e., the material of another food.

The provider of a food may be an agent that provides the food. The provider of a food may include at least one of a food factory, a food store, a restaurant, and a service provider that provides a meal. The service provider may refer to an institution or organization.

The provider of a food may store food information about the food, provided by the provider, in the food information storage 110. For example, the food information may include at least one of material information about the material of the food, manufacturing information about the manufacture of the food, nutritive substance information about the nutritive substances of the food, caloric content information about the calories of the food, ingredient information about the ingredients of the food, production method information about a method of producing the food, manufacturing method information about the method of manufacturing the food, manufacture process information about the process of manufacturing the food, health-related information about the effect of the food on health, taste information about the taste of the food, and seasoning information about a seasoning used in the food. Furthermore, the food information may include additional information about the food in addition to the aforementioned information. The provider of the food may provide the food information storage 110 with a food identifier that enables the identification of the food. The food information storage 110 may provide the food information and the food identifier. For example, different foods may be identified by food identifiers.

The food identifier of the food may be represented in the form of, for example, a code, barcode, QR code, radio-frequency identification (RFID), near field communication (NFC), or iBeacon form. Furthermore, the food identifier may be represented in the form of a code that is now used, or that will be used in the future and identify a food.

The server 120 may provide a user with knowledge information related to the food intake of the user. The server 120 may obtain food information from the food information storage 110 using a food identifier, and may obtain the personal information of the user from the terminal 130. The server 120 may match the personal information of the user against a food using the personal information of the user and food information, and may provide the user with knowledge information related to the food intake of the user via the terminal 130 of the user based on the result of the matching. Hereinafter, knowledge information related to the intake of a food of a user is abbreviated as “knowledge information.”

The server 120 may generate and output notification data including knowledge information. The user may be provided with a service by the server 120 via the terminal 130. The user may obtain knowledge information using the terminal 130.

As described above, the knowledge information may be indicative of information related to the intake of a food of the user. The knowledge information may be indicative of problems related to the intake of a food of the user. For example, the knowledge information may be indicative of whether a food includes an ingredient that causes an allergic reaction within the user that is indicated by the personal information. Furthermore, the knowledge information may indicate that the intake of a food of the user is safe. Furthermore, the knowledge information may be indicative of whether the intake target of a food has been achieved. For example, the knowledge information may be indicative of the achievement status of the intake target of an ingredient of a food that is related to personal information. In some embodiments, the knowledge information may indicate that there is no information that may be provided in relation to the intake of a food of the user, and indicate that an additional check is required. Furthermore, knowledge information may be indicative of whether a food or the attribute of a food complies with the taste of the user that is indicated by personal information.

The user may register the personal information of the user with the terminal 130.

The personal information of the user may include information, i.e., a criterion by which the user determines whether or not to ingest a food. For example, the personal information may include at least one of 1) health state information related to the health state of the user, 2) taste information related to the taste of the user, and 3) control information related to the control or adjustment of the intake of a food.

The health state information may include disease information about the disease of the user. For example, the disease information may include information about the allergy, glycosuria, cholesterol, blood pressure, or obesity of the user. The health state information may be indicative of a food whose intake is prohibited, the type of food, the attribute and ingredient of the food due to the disease of the user, such as an allergy, glycosuria, cholesterol, blood pressure, or obesity.

The taste information may include information about the attribute of the user or the preference or exclusion of the user based on the attribute of a food. The attribute of the user may include the religion of the user, and information about whether the user is a vegetarian. The attribute of a food may include information about whether the food is an organic food, the place of origin of the food, information about whether the food is homemade, the spice of the food, the materials of the food, the method of cooking the food, the distribution environment of the food, an area where the food has been produced, and the manufacturer of the food. The distribution environment may be indicative of whether the food is refrigerated and then distributed, whether the food is frozen and then distributed, and whether the food is delivered on the same day. The taste information may be indicative of whether the food is preferred or excluded, the type of food, the attribute of the food, and the ingredient of the food depending on the religion of the user, information about whether the user is a vegetarian, whether the food is an organic food, the place of origin of the food, information about whether the food is homemade, the spice of the food, the food materials of the food, the method of cooking a food, the distribution environment of the food, a local specialty, and the manufacturer of the food.

The control information may include information about the control of the amount of intake of a specific food or a specific ingredient of a food, such as calorie, sugar content, calcium, and salt. The control of the amount of intake may refer to the control of the target amount of intake, an intake upper limit, and an intake lower limit per unit period. The unit period may be a specific period related to the intake of a food, such as 1 hour, one meal, 8 hours, or a day.

Furthermore, the personal information of the user may include at least one of the health state information and taste information of the user's family as well as the user, and information about the amount of intake of the user's family as well as the amount of intake of the user. For example, the information about a taste or a disease, such as an allergy, may be common to the members of a family.

The user may search for information about a food of interest using the terminal 130. Upon searching for information about a food, an input method, such as key input, touch input, or the scanning of a code, may be used. For example, the terminal 130 may obtain a food identifier through an input, touch or code scan made by the user. The terminal 130 may send a food identifier to the server 120, and may receive notification data, including knowledge information, from the server 120. The terminal 130 may output knowledge information.

For example, prior to the intake of a food, the user may obtain knowledge information through the terminal 130, and may be provided with an early personalized warning for a food depending on the health state or taste of the user by the server 120. The user may determine whether or not to ingest the food based on the provided information.

The personal information of the user that is provided to the server 120 may include a search condition required by the user. For example, a search condition may be indicative of a type or category that belongs to information related to a food and that is required by the user. Upon searching for food information, a user may specify a search condition. The type of knowledge information provided by the server 120 may be specified based on the search condition. For example, regarding the type of knowledge information, i.e., a subject of search, a search condition may be designated as one of information related to a health state, information related to a taste, and information related to the amount of intake. Alternatively, regarding the type of knowledge information, the search condition may be designated as one of 1) information related to a specific disease of the user, 2) information related to a specific preference, such as a religion of the user or the place of origin, and 3) information related to the amount of intake of a specific food or specific ingredient.

In other words, whether a food to be ingested by the user is good or harmful for the user can be checked through the aforementioned personalized food information service. Accordingly, upon determining whether or not to ingest a food, the user may be provided with a criterion for the determination. Furthermore, the user who needs to manage the intake of an ingredient of a food, such as calories or a nutritive substance, may be provided with information about content of the ingredient through the personalized food information service. Such information may be helpful for the user to control the amount of intake of a food.

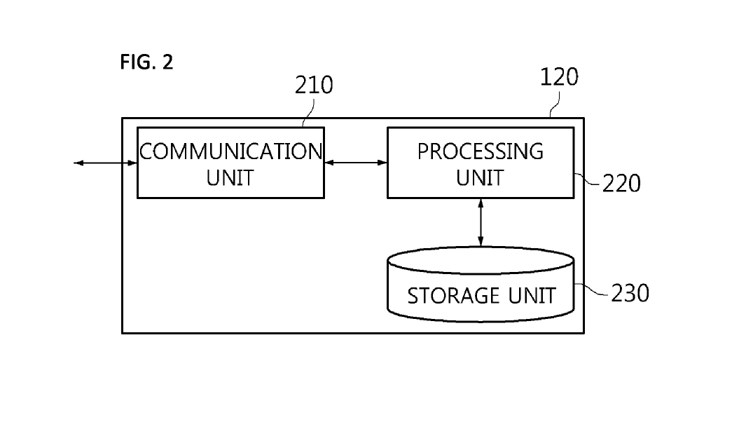

FIG. 2 illustrates the configuration of the server according to an embodiment of the present invention.

The server 120 may include a processing unit 220, a communication unit 210, and a storage unit 230.

The processing unit 220 may execute code, instructions, a program, and a module for the operation of the server 120. For example, the processing unit 220 may be a processor.

The communication unit 210 may receive data from another device and send data to another device. For example, the communication unit 210 may be a chip or port for communication.

The storage unit 230 may store data for the operation of the server 120. For example, the storage unit 230 may be a medium for storing data, such as memory or a disk. Furthermore, for example, the storage unit 230 may be a database.

The functions of the processing unit 220, the communication unit 210, and the storage unit 230 are described in detail with reference to embodiments below.

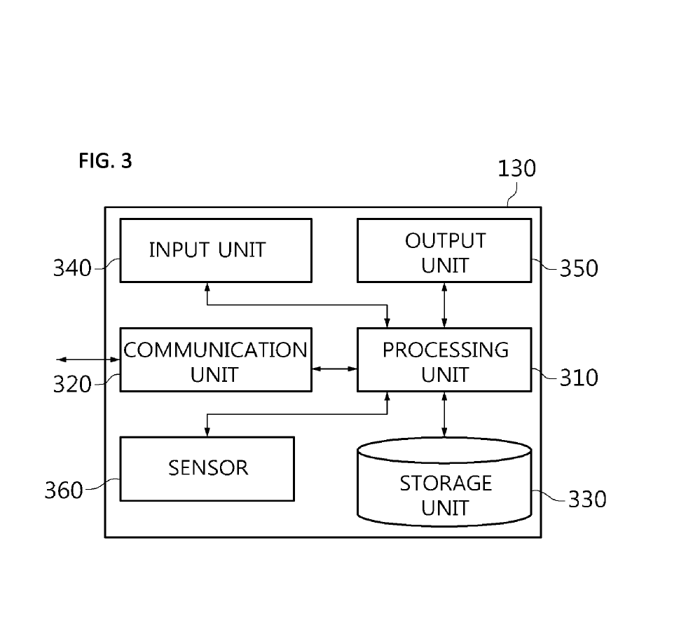

FIG. 3 illustrates the configuration of the terminal according to an embodiment of the present invention.

The terminal 130 may include a processing unit 310, a communication unit 320, a storage unit 330, an input unit 340, an output unit 350, and a sensor 360.

The processing unit 310 may execute code, instructions, a program, and a module for the operation of the terminal 130. For example, the processing unit 310 may be a processor.

The communication unit 320 may receive data from another device and send data to another device. For example, the communication unit 320 may be a chip or port for communication.

The storage unit 330 may store data for the operation of the terminal 130. For example, the storage unit 330 may be a medium for storing data, such as memory or a disk. Furthermore, for example, the storage unit 330 may be a database.

The input unit 340 may receive data for the operation of the terminal 130 from a user. For example, the input unit 340 may be at least one of a keyboard, a keypad, a mouse, and a touch screen.

The output unit 350 may output data. For example, the output unit 340 may be at least one of a display and a speaker.

The sensor 360 may detect information or a state related to the five senses, such as audio and video and generated data indicative of a detected information or state. For example, the sensor 360 may be at least one of a camera, a microphone, and a scanner.

The functions of the processing unit 310, the communication unit 320, the storage unit 330, the input unit 340, the output unit 350, and the sensor 360 are described in detail with reference to embodiments below.

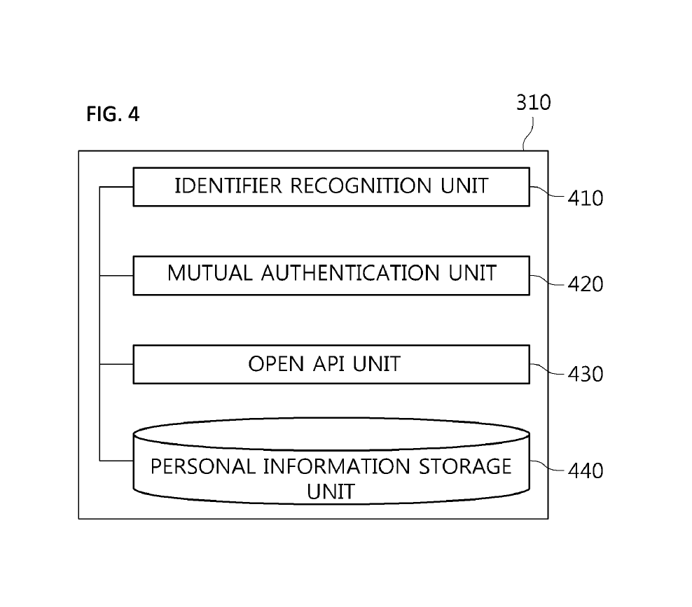

FIG. 4 illustrates the functions of the terminal according to an embodiment of the present invention.

According to an embodiment of the present invention, the processing unit 310 may include an identifier recognition unit 410, a mutual authentication unit 420, and an open application programming interface (API) unit 430.

Alternatively, the identifier recognition unit 410, the mutual authentication unit 420, and the open API unit 430 may be program modules that are executed by the processing unit 310. The program modules may be included in the terminal 130 in the form of an operating system, an application program, a module, and other program modules. The storage unit 330 may store the code of the program modules. The processing unit 310 may execute the program modules using the code of the program modules that are stored in the storage unit 330. Furthermore, at least some of the program modules may be stored in remote storage that can communicate with the terminal 130. The program modules include routines, subroutines, programs, objects, components, and data structures for performing a specific task to be described later or executing a specific abstraction data type, but are not limited thereto. In exemplary embodiments, functions that have been illustrated as being processed by the identifier recognition unit 410, the mutual authentication unit 420 and the open API unit 430 may be considered to be functions that are processed by the processing unit 310.

The identifier recognition unit 410 may receive the food identifier of a food via the input unit 340 or the sensor 360. For example, the identifier recognition unit 410 may receive the food identifier of a food via a user input using the input unit 340. The user may input a number, string, or code indicative of a food identifier to the terminal 130 using the input unit 340. Furthermore, the identifier recognition unit 410 may recognize the food identifier of a food using the sensor 360. The sensor 360 may recognize a code, a barcode, a QR code, an RFID tag, an NFC signal, or iBeacon indicative of a food identifier.

The mutual authentication unit 420 may perform mutual authentication between a user and the terminal 130. Since the personal information of a user is input via the terminal 130, the mutual authentication between the user and the terminal 130 may be required for the safety of personal information.

In order for the server 120 to provide service to a variety of types of terminals, a unified interface is required. The open API unit 430 may provide a unified interface required to provide service. For example, the transmission of notification data, personal information, and a product identifier may require a unified interface for various terminals. The server 120 may send data to various terminals in a single form via the open API unit 430.

According to an embodiment of the present invention, the storage unit 330 may include a personal information storage unit 440. The user may input the personal information of the user via the input unit 340. The personal information storage unit 440 may store the personal information of the user that has been input by the user. Furthermore, the personal information storage unit 440 may store already obtained knowledge information.

When notification data including knowledge information is transmitted from the server 120 to the terminal 130, the processing unit 310 may store the knowledge information in the personal information storage unit 440 for future use. For example, when the user searches for a specific food in a restaurant, the server 120 may provide knowledge information to the user. The personal information storage unit 440 may store knowledge information about a retrieved food. If the user searches for the same food using the same search condition, the processing unit 310 of the terminal 130 may search for knowledge information stored in the personal information storage unit 440 and may not request information from the server 120 again. If a search condition related to the same food is changed, the processing unit 310 of the terminal 130 may request knowledge information from the server 120.

If knowledge information is stored in the personal information storage unit 440, the stored information may be used to monitor the eating habits of a user.

When notification data is received from the server 120, the processing unit 310 may output a message indicative of knowledge information via the output unit 350. For example, the output message may be indicative of a problem or attention in the intake of a food of the user. The output message may be indicative of the achievement or non-achievement of the amount of intake per unit period in the food of the user or the ingredient of the food. The output message may indicate that the user may ingest the food. Furthermore, the output message may indicate that there is no information about the food.

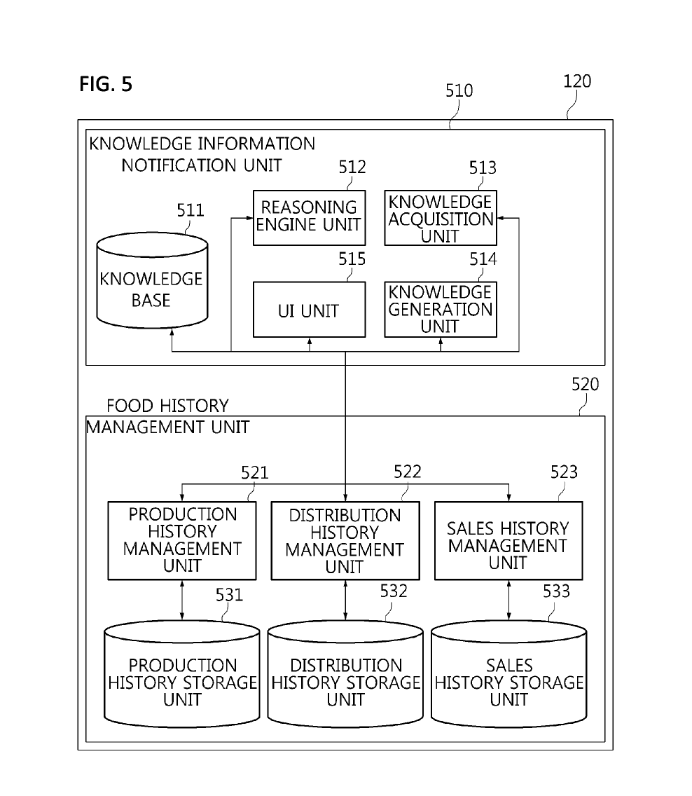

FIG. 5 illustrates the functions of the server according to an embodiment of the present invention.

According to an embodiment of the present invention, the processing unit 220 may include a knowledge information notification unit 510 and a food history management unit 520. The knowledge information notification unit 510 may include a reasoning engine unit 512, a knowledge acquisition unit 513, a knowledge generation unit 514, and a user interface (UI) unit 515. The food history management unit 520 may include a production history management unit 521, a distribution history management unit 522, and a sales history management unit 523.

Alternatively, the knowledge information notification unit 510, the food history management unit 520, the reasoning engine unit 512, the knowledge acquisition unit 513, the knowledge generation unit 514, the UI unit 515, the production history management unit 521, the distribution history management unit 522, and the sales history management unit 523 may be program modules that are executed by the processing unit 220. The program modules may be included in the server 120 in the form of an operating system, an application program module, and other program modules. The storage unit 230 may store the code of the program modules. The processing unit 220 may execute the program modules using the code of the program modules that are stored in the storage unit 230. Furthermore, at least some of the program modules may be stored in a remote storage capable of communication with the server 120. In exemplary embodiments, the functions that have been illustrated as being processed by the knowledge information notification unit 510, the food history management unit 520, the reasoning engine unit 512, the knowledge acquisition unit 513, the knowledge generation unit 514, the UI unit 515, the production history management unit 521, the distribution history management unit 522 and the sales history management unit 523 may be considered to be the functions that are processed by the processing unit 310.

According to an embodiment of the present invention, the storage unit 230 may include a knowledge base 511, a production history storage unit 531, a distribution history storage unit 532, and a sales history storage unit 533. The knowledge base 511 may be used by the knowledge information notification unit 510. The production history storage unit 531, the distribution history storage unit 532, and the sales history storage unit 533 may be respectively used and maintained by the production history management unit 521, the distribution history management unit 522, and the sales history management unit 523.

The knowledge information notification unit 510 may generate knowledge information related to the intake of a food of the user using food information and the personal information of the user, and may generate notification data including the knowledge information. The knowledge information notification unit 510 may manage an early personalized warning by providing knowledge information.

The knowledge information notification unit 510 may receive the food identifier of a food and the personal information of the user from the terminal 130 via the communication unit 210. Furthermore, the knowledge information notification unit 510 may send knowledge information to the terminal 130 via the communication unit 210.

The knowledge base 511 may store knowledge information about a food that is provided by the provider of the food. The communication unit 210 may receive knowledge information from the food information storage 110. The knowledge base 511 may store the received knowledge information. Furthermore, when the server 120 provides a personalized food information service, the knowledge base 511 may store the knowledge information provided by the knowledge generation unit 514.

The reasoning engine unit 512 may search the knowledge base 511 using food information and personal information, and may search the food history management unit 520 for a food history. The reasoning engine unit 512 may obtain or generate knowledge information through reasoning for searching the knowledge base and food histories with respect to personal information.

The knowledge generation unit 514 may convert generated knowledge information into a form that can be added to the knowledge base 511.

The knowledge acquisition unit 513 may store the converted knowledge information in the knowledge base 511.

The UI unit 515 may provide a UI via which the provider of a food or the operator of the knowledge base 511 inputs knowledge information to the knowledge base 511. The UI unit 515 may suggest various formats and conditions for inputting knowledge information. Information input according to the formats and conditions may be input as knowledge.

The food history management unit 520 may provide the knowledge information notification unit 510 with food information and history information about the history of the food. The food history management unit 520 may perform the tracking and management of the food history. The food history may include at least one of the production history, distribution history and sales history of the food, but is not limited to the histories.

The food history management unit 520 may receive food information and history information via the communication unit 210 and store the received food information. The provider of the food may input food information and history information, provided by the provider, to the food history management unit 520.

According to an embodiment of the present invention, the knowledge information notification unit 510 and the food history management unit 520 may be implemented in separate physical servers. For example, the server 120 may include a knowledge information notification server configured to provide a knowledge information notification unit, and a food history management server configured to provide a food history management unit. A personalized food information service may be provided through the cooperation between the knowledge information notification server and the food history management server. The knowledge information notification server and the food history management server may be managed by separate operators. For example, the knowledge information notification server may be managed by the provider of a personalized food information service, such as a public institution. The food history management server may be managed by the manufacturer of a food or the provider of a food, such as a restaurant. If the number of providers of a food is plural, the number of food history management servers may be plural.

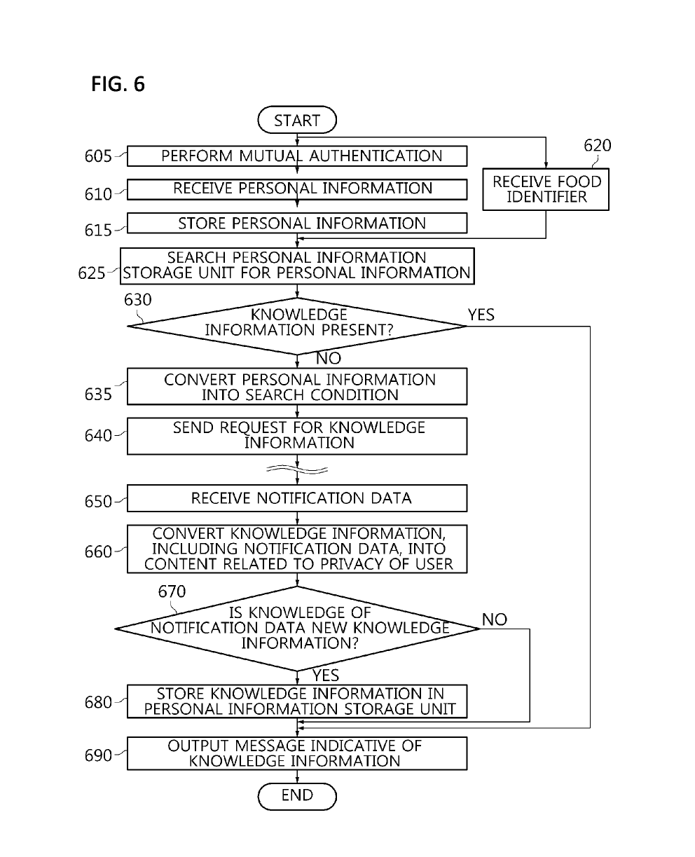

FIG. 6 is a flowchart illustrating a method of providing personalized food information using the terminal according to an embodiment of the present invention.

In the following embodiment, the operation of the terminal 130 for providing personalized food information is described below.

At step 605, the mutual authentication unit 420 of the terminal 130 may perform mutual authentication between a user and the terminal 130.

At step 610, if the mutual authentication is successful, the user may input the personal information of the user via the input unit 340. The input unit 340 may receive the personal information input by the user.

At step 615, the processing unit 310 may store the input personal information in the personal information storage unit 440.

At step 620, the identifier recognition unit 410 may receive the food identifier of a food via the input unit 340 or the sensor 360.

The order of steps 605, 610, 615 and 620 is merely illustrative, and may be changed.

At step 625, the processing unit 220 of the terminal 130 may search the personal information storage unit 440 for the personal information of the user and knowledge information about the food that is indicated by the food identifier.

At step 630, the processing unit 220 may determine whether the personal information and the knowledge information about the food are present in the personal information storage unit 440. If it is determined that the personal information and the knowledge information about the food are present in the personal information storage unit 440, the processing unit 220 does not need to request another knowledge information from the server 120, and step 690 may be performed. If it is determined that the personal information and the knowledge information about the food are not present in the personal information storage unit 440, step 635 may be performed.

At step 635, the processing unit 310 of the terminal 130 may perform the conversion of the personal information to be provided to the server 120. If the personal information includes content that may infringe upon the privacy of the user, the processing unit 310 may convert the personal information into a search condition related to the attribute of the food. In other words, the processing unit 310 may generate the search condition by converting the personal condition, including content that may infringe upon the privacy of the user, into content that do not violate privacy.

For example, if the personal information is disease information indicative of a disease of the user, the processing unit 310 may specify a food or a list of foods related to the disease, and may convert the personal information into a search condition that queries whether a food indicated by a food identifier is a specific food or any of foods included in a specific list. Alternatively, if the personal information is disease information, the processing unit 310 may specify a food material or ingredient related to the disease, and may convert the personal information into a search condition that queries whether a food indicated by a food identifier includes a specific food material or ingredient. Furthermore, if the personal information is indicative of an allergy of a user for a specific ingredient, the processing unit 310 may convert the personal information into a search condition that queries whether a food indicated by a food identifier includes a specific ingredient.

For example, if the personal information is indicative of the intake target of a specific ingredient, a nutritive substance, or calories, the processing unit 310 may convert the personal information indicative of the intake target into a search condition that queries the amount of the ingredient, the amount of the nutritive substance, or the calories of the food.

At step 640, the processing unit 310 may send a request for the knowledge information to the server 120 via the communication unit 320. The request for the knowledge information may include the food identifier. Furthermore, the request for the knowledge information may include the personal information.

When the request for the knowledge information is sent to the server 120, the knowledge information may be provided by the server 120. The knowledge information may be generated based on the food information indicated by the food identifier and the personal information.

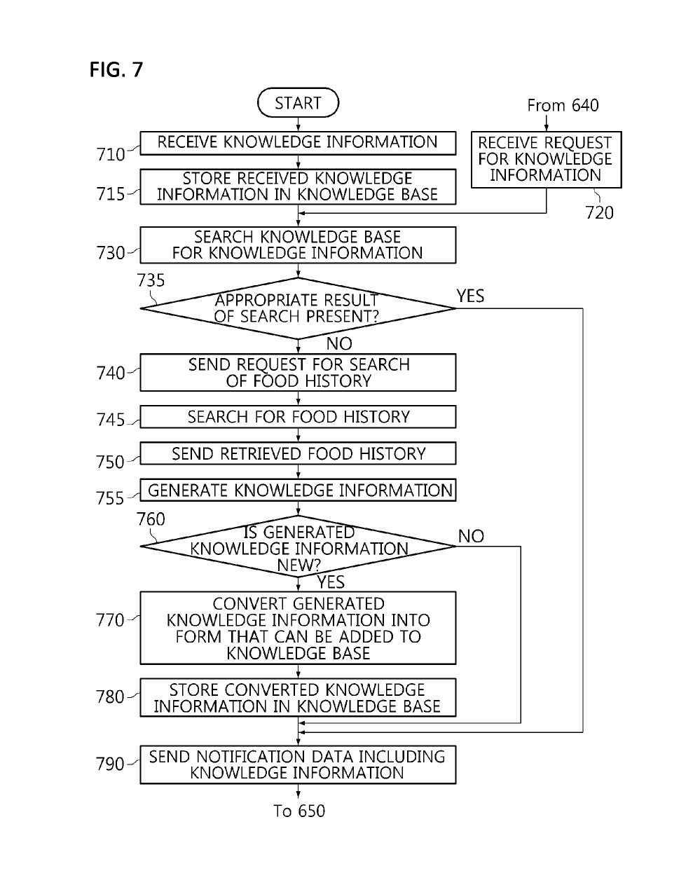

An embodiment to be described later with reference to FIG. 7 may be performed between steps 640 and 650.

At step 650, the communication unit 320 may receive notification data, including the knowledge information, from the server 120.

At step 660, the processing unit 310 may convert the knowledge information into content related to the privacy of the user. Steps 630 and 660 may be selectively performed, and may have a corresponding step. In other words, the privacy of the user is not provided to the server 120 through steps 630 and 660, and the knowledge information may be provided.

For example, if the knowledge information indicates that a food includes a specific food material or ingredient and the specific food material or ingredient is related to a disease of the user, the processing unit 310 may convert the knowledge information, indicating that the food includes the specific food material or ingredient, into knowledge information indicative of a problem with the food intake of the user. Alternatively, the processing unit 310 may convert the knowledge information, indicating that the food includes the specific food material or ingredient, into knowledge information indicative of the prohibition of the food intake of the user. Furthermore, if the knowledge information indicates that a food does not include a specific food material or ingredient and the specific food material or ingredient is related to a disease of the user, the processing unit 310 may convert the knowledge information, indicating that the food does not include the specific food material or ingredient, into knowledge information indicating that the user may safely ingest the food.

For example, if the knowledge information indicates that a food includes a specific food material or ingredient and the specific food material or ingredient is related to a taste of the user, the processing unit 310 may convert the knowledge information, indicating that the food includes the specific food material or ingredient, into knowledge information indicating that the food complies or does not comply with the taste of the user.

Alternatively, if the knowledge information is indicative of the amount of an ingredient or a nutritive substance, or the caloric content of a food, the processing unit 310 may convert the knowledge information indicative of the amount of the ingredient, nutritive substance, or the caloric content of the food into knowledge information indicating whether the ingredient, nutritive substance, or the caloric content of the food satisfies the intake target of the user.

At step 670, the processing unit 310 may check whether the knowledge information of the notification data is knowledge information newer than existing knowledge information. If the knowledge information of the notification data is found to be new knowledge information, step 680 may be performed in order to store the knowledge information. If the knowledge information of the notification data is found not to be new knowledge information, step 690 may be performed.

At step 680, the processing unit 310 may store the received knowledge information in the personal information storage unit 440. The stored knowledge information may be provided when the user uses the terminal 130 again.

At step 690, the processing unit 310 may output a message indicative of the knowledge information via the output unit 350. The message may be output in the form of letters, figures, voice, or sound, or may be output in various forms that may be recognized by a user.

FIG. 7 is a flowchart illustrating a method of providing personalized food information using the server according to an embodiment.

In the following embodiment, the operation of the server 120 for providing personalized food information is described below.

At step 710, the server 120 may receive knowledge information. For example, the UI unit 515 of the server 120 may receive the knowledge information input by the provider of a food or the operator of the knowledge base 511. Alternatively, the communication unit 210 of the server 120 may receive the knowledge information from the food information storage 110 managed by the provider of a food.

At step 715, the processing unit 220 of the server 120 may store the received knowledge information in the knowledge base 511. Steps 710 and 715 may be considered to be a process of constructing an environment for providing a personalized food information service using the server 120.

At step 720, the communication unit 210 may receive a request for the knowledge information from the terminal 130. The order of steps 710, 715, and 720 is merely illustrative, and may be changed. Furthermore, step 720 may be performed after step 640 described with reference to FIG. 6.

The request for the knowledge information may include a food identifier. Furthermore, the request for the knowledge information may include personal information.

At step 730, the reasoning engine unit 512 may search the knowledge base 511 of the server 120 for the knowledge information, corresponding to the food information and the personal information, using the food information and the personal information.

At step 735, the reasoning engine unit 512 may analyze whether an appropriate search result is present as the knowledge information. If an appropriate result of the search is present, step 790 may be performed. If an appropriate result of the search is not present, step 740 may be performed in order to generate new knowledge.

At step 740, the knowledge information notification unit 510 may send a request for a search for the food history of a food, indicated by the food identifier, to the food history management unit 520.

At step 745, the knowledge information notification unit 510 may search for the food history. Upon searching for the food history, the production history management unit 521, the distribution history management unit 522, and the sales history management unit 523 may search the production history storage unit 531, the distribution history storage unit 532, and the sales history storage unit 533, respectively. The production history management unit 521, the distribution history management unit 522, and the sales history management unit 523 may obtain the production history, distribution history, and sales history of the food as the results of the search.

At step 750, the food history management unit 520 may send the retrieved food history to the knowledge information notification unit 510.

At step 755, the reasoning engine unit 512 may reason the knowledge information using the received food history. For example, if the food history includes information required for the reasoning of the knowledge information, such as information about the food materials of the food or information about the manufacture of the food, the reasoning engine unit 512 may generate knowledge information through reasoning based on the food history and the personal information.

At step 760, the reasoning engine unit 512 may determine whether the generated knowledge information is newer than existing knowledge information stored in the knowledge base 511. If it is determined that the generated knowledge information is not newer than the existing knowledge information, it may be considered that knowledge information to be provided to a user has not been found and generated, and step 790 may be performed in order to provide notification that there is no information to be provided to the user. If it is determined that the generated knowledge information is new knowledge information, step 770 may be performed in order to add the new knowledge information.

At step 770, the knowledge generation unit 514 may convert the generated knowledge information into a form that can be added to the knowledge base 511.

At step 780, the knowledge acquisition unit 513 may store the converted knowledge information in the knowledge base 511.

At step 790, the knowledge information notification unit 510 may send notification data, including the knowledge information, to the terminal 130 via the communication unit 210.

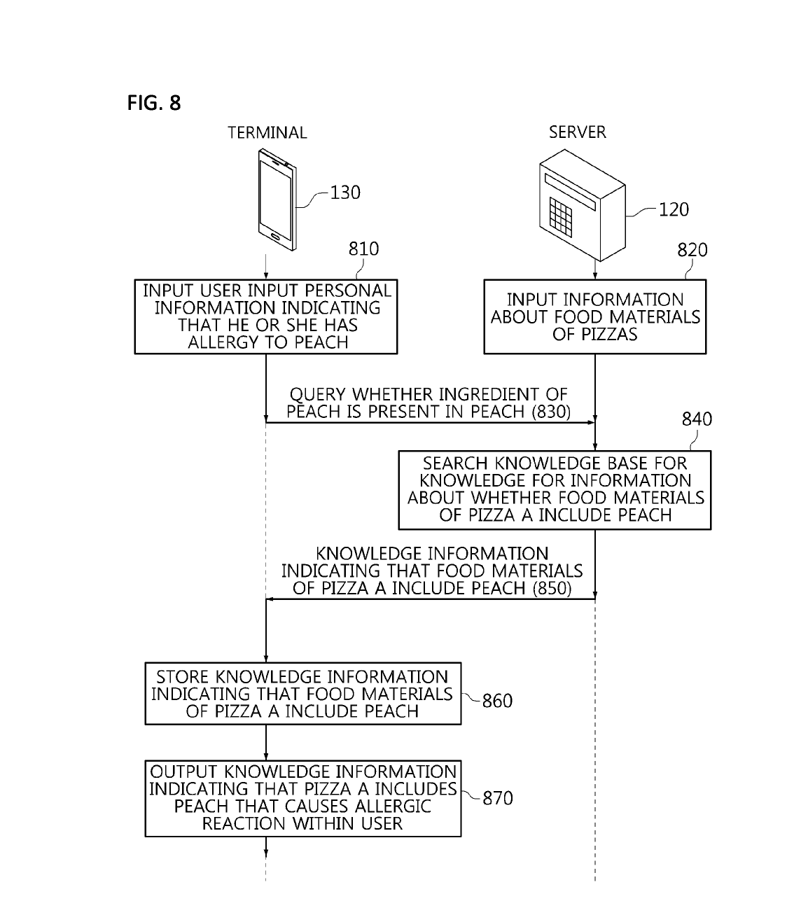

FIGS. 8 to 10 illustrate more detailed embodiments of a personalized food information service.

FIG. 8 illustrates a personalized food information service for a user having an allergy according to an example.

At step 810, the user of the terminal 130 may input personal information, indicating that he or she has an allergy to a peach, via the input unit 340 of the terminal 130. The input unit 340 may receive the personal information, indicating that the user has an allergy to the peach. Step 810 may correspond to steps 615 and 620 described above with reference to FIG. 6.

At step 820, a food provider who manages a pizza restaurant may input information about the food materials of pizzas to the knowledge base 511. The knowledge base 511 may receive the information about the food materials of the pizzas. For example, the food provider may input cheese, tomatoes, and peaches to the knowledge base 511 as the food materials of a pizza A. Step 820 may correspond to steps 710 and 715 described above with reference to FIG. 7.

The user may visit the pizza restaurant, and may examine whether or not to place an order for the pizza A of the pizzas sold in the pizza restaurant.

At step 830, the user may search for knowledge information about the pizza A using the terminal 130. The communication unit 320 of the terminal 130 may send a request for the knowledge information about the pizza A to the communication unit 210 of the server 120. For example, the user may input the food identifier of the pizza A to the terminal 130 via the input unit 340 or the sensor 360. The input unit 340 or sensor 360 of the terminal 130 may receive the food identifier of the pizza A. Step 830 may correspond to steps 620, 625, 630, 635, and 640 described above with reference to FIG. 6.

Upon searching for the knowledge information, the processing unit 220 may perform the conversion of the personal information to be provided to the server 120 before sending the request for the knowledge information to the server 120. Although the personal information indicating that the user has an allergy to a peach has been stored in the personal information storage unit 440, the processing unit 310 may convert the personal information, indicating that the user has an allergy to a peach, into a search condition that queries whether the ingredients of a peach are present in the pizza A.

The communication unit 320 of the terminal 130 may send the query regarding whether the ingredients of a peach are present in the pizza A to the communication unit 210 of the server 120.

At step 840, the reasoning engine unit 512 may search the knowledge base 511 for knowledge information corresponding to the food information of the pizza A and the search condition. The reasoning engine unit 512 may search whether the food materials of the pizza A include a peach. Step 840 may correspond to step 730 described above with reference to FIG. 7.

At step 850, if the food materials of the pizza A are found to include a peach, the knowledge information notification unit 510 may send notification data, including the knowledge information, via the communication unit 210. The knowledge information may indicate that the food materials of the pizza A include a peach. Step 850 may correspond to step 790 described above with reference to FIG. 7.

The communication unit 320 of the terminal 130 may receive the notification data.

At step 860, the processing unit 310 of the terminal 430 may store the knowledge information, indicating that the food materials of the pizza A include a peach, in the personal information storage unit 440. Step 860 may correspond to step 670 described above with reference to FIG. 6.

At step 870, the processing unit 310 may output the knowledge information, indicating that the pizza A includes a peach, via the output unit 350. Step 870 may correspond to steps 660, 670, 680, and 690 described above with reference to FIG. 6.

The processing unit 310 may convert the knowledge information, indicating that the pizza A includes a peach, into knowledge information indicative of a warning that the pizza A includes a peach that causes an allergic reaction within the user. Furthermore, the processing unit 310 may convert the knowledge information, indicating that the pizza A includes a peach, into knowledge information indicating that the user should not ingest the pizza A, including a peach, due to an allergy to a peach, and may output the converted knowledge information via the output unit 350.

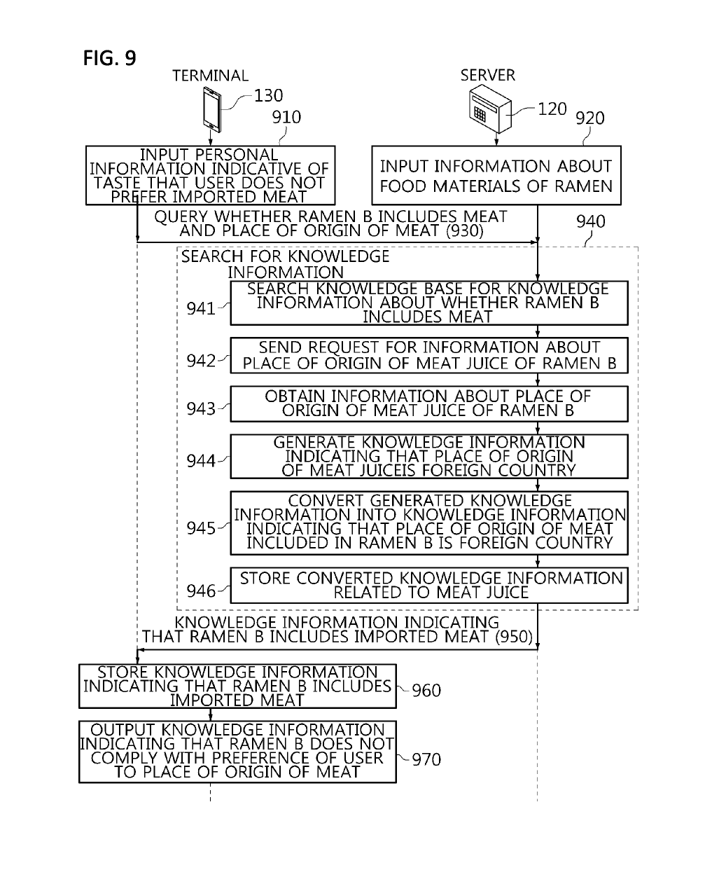

FIG. 9 illustrates a personalized food information service for a user who prefers food from a specific place of origin according to an example.

At step 910, the user of the terminal 130 may input personal information indicative of a taste that he or she does not prefer imported meat via the input unit 340 of the terminal 130. The input unit 340 may receive the personal information indicative of the taste that the user does not prefer imported meat. Step 910 may correspond to steps 615 and 620 described above with reference to FIG. 6.

At step 920, a food provider who manufactures ramen may input information about the food materials of the ramen to the knowledge base 511. For example, the food provider may input noodle, meat juice, and vegetable to the knowledge base 511 as the food materials of a ramen B. The knowledge base 511 may receive information about the food materials of the ramen. Step 920 may correspond to steps 710 and 715 described above with reference to FIG. 7.

The user may visit a food store, and may examine whether or not to place an order for the ramen B of the foods sold in the food store.

At step 930, the user may search knowledge information about the ramen B using the terminal 130. The communication unit 320 of the terminal 130 may send a request for the knowledge information about the ramen B to the communication unit 210 of the server 120. For example, the user may input the food identifier of the ramen B to the terminal 130 via the input unit 340 or the sensor 360. Step 930 may correspond to steps 620, 625, 630, 635, and 640 described above with reference to FIG. 6.

In search for the knowledge information, before the processing unit 220 sends the request for the knowledge information to the server 120, it may perform the conversion of the personal information to be provided to the server 120. Although the personal information indicative of the taste that the user does not prefer imported meat has been stored in the personal information storage unit 440, the processing unit 310 may convert the personal information about the taste into a search condition that queries whether the ramen B includes meat and the place of origin of meat included in the ramen B.

The communication unit 320 of the terminal 130 may send the query regarding whether the ramen B includes meat and the place of origin of meat included in the ramen B to the communication unit 210 of the server 120.

At step 940, the reasoning engine unit 512 may search the knowledge base 511 for knowledge information corresponding to the food information and search condition of the ramen B. The reasoning engine unit 512 may search for knowledge information about whether the ramen B includes meat and the place of origin of meat included in the ramen B. Step 940 may correspond to step 730 described above with reference to FIG. 7.

Step 940 may include steps 941, 942, 943, 944, 945, and 946 below.

At step 941, the reasoning engine unit 512 may search the knowledge information about whether the ramen B includes meat via the knowledge base 511. The meat juice of the ramen B may be found as a result of the search. The knowledge base 511 may send the food identifier of the meat juice to the reasoning engine unit 512 as a result of the search. However, the place of origin of the meat juice of the ramen B may not be found in the knowledge base 511. Step 941 may correspond to steps 730 and 740 described above with reference to FIG. 7.

If the ramen B is found to include meat, the reasoning engine unit 512 may send a request for information about the place of origin of a food, indicated by the food identifier of the meat juice of the ramen B, to the production history management unit 521 of the food history management unit 520 at step 942. Step 942 may correspond to step 740 described above with reference to FIG. 7.

At step 943, in response to the request, the production history management unit 521 may send information about the place of origin of the food, indicated by the food identifier, to the reasoning engine unit 512. The reasoning engine unit 512 may obtain the information about the place of origin of the food, indicated by the food identifier, from the production history management unit 521. Step 943 may correspond to steps 745 and 750 described above with reference to FIG. 7.

At step 944, the reasoning engine unit 512 may identify that meat used in the meat juice is imported meat based on the information about the place of origin, and may generate new knowledge information indicating that the place of origin of the meat juice is a foreign country. Step 944 may correspond to steps 755 and 760 described above with reference to FIG. 7.

At step 945, the knowledge generation unit 514 may convert the knowledge information, indicating that the place of origin of the meat juice is a foreign country, into knowledge information indicating that the place of origin of the food indicated by the food identifier is a foreign country. The knowledge generation unit 514 may convert the knowledge information, indicating that the place of origin of the meat juice is a foreign country, into knowledge information indicating that the place of origin of the meat included in the ramen B having the meat juice as a food material or ingredient is a foreign country. In other words, the knowledge generation unit 514 may convert the knowledge information, indicating that the place of origin of a specific food is a foreign country and the specific food includes a food material or ingredient of another food, into knowledge information indicating that the place of origin of the food material or ingredient of another food is a foreign country. Step 945 may correspond to step 770 described above with reference to FIG. 7.

At step 946, the knowledge acquisition unit 513 may store the converted knowledge information related to the meat juice in the knowledge base 511. Step 946 may correspond to step 780 described above with reference to FIG. 7.

At step 950, if the ramen B is found to include imported meat, the knowledge information notification unit 510 may send notification data, including the knowledge information, via the communication unit 210. The knowledge information may indicate that the ramen B includes imported meat. Step 950 may correspond to step 790 described above with reference to FIG. 7.

The communication unit 320 of the terminal 130 may receive the notification data.

At step 960, the processing unit 310 of the terminal 430 may store the knowledge information, indicating that the ramen B includes imported meat, in the personal information storage unit 440. Step 960 may correspond to step 670 described above with reference to FIG. 6.

At step 970, the processing unit 310 may output the knowledge information indicating that the ramen B includes imported meat via the output unit 350. Step 970 may correspond to steps 660, 670, 680 and 690 described above with reference to FIG. 6.

The processing unit 310 may convert the knowledge information, indicating that the ramen B includes imported meat, into knowledge information indicating that the ramen B does not comply with the preference of the user to the place of origin of meat, and may output the converted knowledge information via the output unit 350.

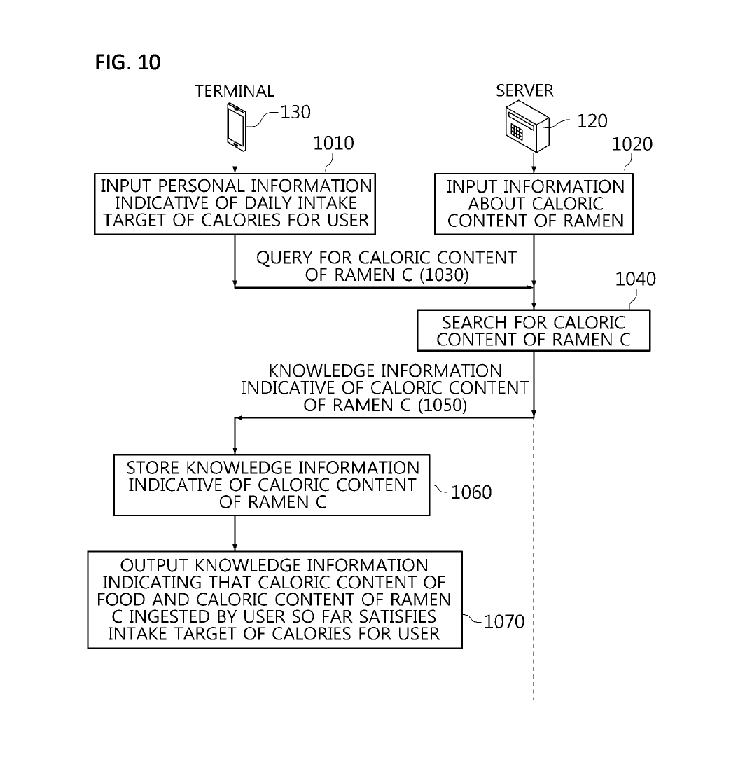

FIG. 10 illustrates a personalized food information service for a user who has a diet target according to an example.

At step 1010, the user of the terminal 130 may input personal information, indicating that he or she aims to ingest a caloric content equal to or less than 2500 kcal a day, via the input unit 340 of the terminal 130. The input unit 340 may receive the personal information, indicating that he or she aims to ingest a caloric content equal to or less than 2500 kcal a day. Step 1010 may correspond to steps 615 and 620 described above with reference to FIG. 6

At step 1020, a food provider who manufactures ramen may input information about the food materials of the ramen to the knowledge base 511. For example, the food provider may input the caloric content of a ramen C to the knowledge base 511. The knowledge base 511 may receive information about the caloric content of the ramen. Step 1020 may correspond to steps 710 and 715 described above with reference to FIG. 7.

The user may visit a food store, and may examine whether or not to place an order for the ramen C of the foods sold in the food store.

At step 1030, the user may search for knowledge information about the ramen C using the terminal 130. The communication unit 320 of the terminal 130 may send a request for the knowledge information about the ramen C to the communication unit 210 of the server 120. For example, the user may input the food identifier of the ramen C to the terminal 130 via the input unit 340 or the sensor 360. Step 830 may correspond to steps 620, 625, 630, 635, and 640 described above with reference to FIG. 6.

Upon searching for the knowledge information, before the processing unit 220 sends the request for the knowledge information to the server 120, it may perform the conversion of the personal information to be provided to the server 120. Although the personal information indicating that the user aims to ingest the caloric content equal to or less than 2500 kcal a day has been stored in the personal information storage unit 440, the processing unit 310 may convert the personal information, indicating that the user aims to ingest the caloric content equal to or less than 2500 kcal a day, into a search condition that queries the caloric content of the ramen C.

The communication unit 320 of the terminal 130 may send the query of the caloric content of the ramen C to the communication unit 210 of the server 120.

At step 1040, the reasoning engine unit 512 may search the knowledge base 511 for knowledge information corresponding to food information and the search condition for the ramen C. The reasoning engine unit 512 may search for the caloric content of the ramen C. Step 1040 may correspond to step 730 described above with reference to FIG. 7.

At step 1050, if the caloric content of the ramen C is found to include 500 kcal, the knowledge information notification unit 510 may send notification data including the knowledge information via the communication unit 210. The knowledge information may indicate that the caloric content of the ramen C is 500 kcal. Step 1050 may correspond to step 790 described above with reference to FIG. 7.

The communication unit 320 of the terminal 130 may receive the notification data.

At step 1060, the processing unit 310 of the terminal 430 may store the knowledge information, indicating that the caloric content of the ramen C is 500 kcal, in the personal information storage unit 440. Step 1060 may correspond to step 670 described above with reference to FIG. 6.

At step 1070, the processing unit 310 may output the knowledge information, indicating that the caloric content of the ramen C is 500 kcal, via the output unit 350. Step 1070 may correspond to steps 660, 670, 680, and 690 described above with reference to FIG. 6.

The processing unit 310 may convert the knowledge information, indicating that the caloric content of the ramen C is 500 kcal, into knowledge information indicating that the intake of the ramen C satisfies the intake target of the calories for the user. Furthermore, the processing unit 310 may convert the knowledge information, indicating that the caloric content of the ramen C is 500 kcal, into knowledge information indicating that the sum of the caloric content of a food and the caloric content of the ramen C ingested by the user so far satisfies the intake target of the calories for the user, and may output the converted knowledge information via the output unit 350.

If the user has ingested the ramen C, the user may input personal information, indicating that he or she has ingested the ramen C, or personal information, indicating that 500 kcal has been added to calories ingested today, to the terminal 130.

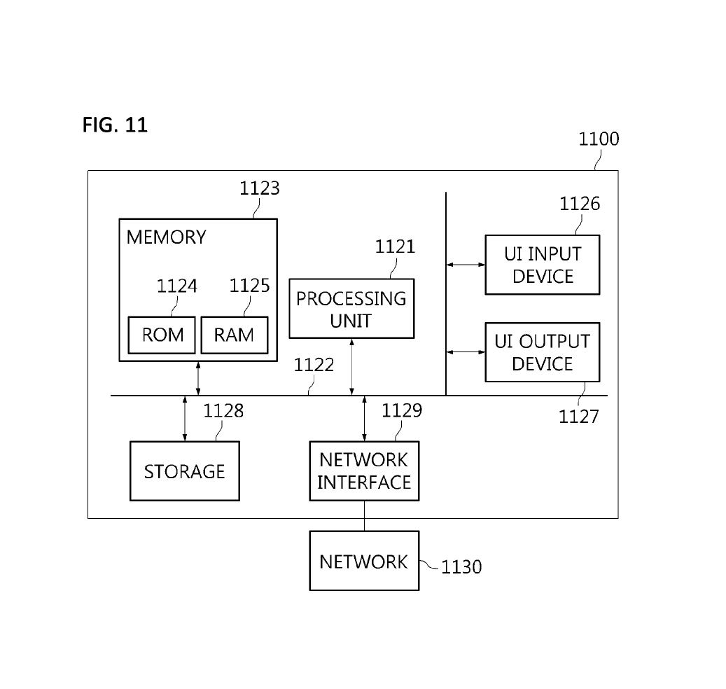

FIG. 11 illustrates a computer system for performing the method of the aforementioned embodiments.

The aforementioned embodiments may be implemented in a computer system including a computer-readable recording medium. As illustrated in FIG. 11, the computer system 1100 may include at least one processing unit 1121, at least one piece of memory 1123, at least one user interface (UI), at least one input device 1126, at least one UI output device 1127, and at least one piece of storage 1128 that communicate with each other over a bus 1122. The computer system 1100 may further include a network interface 1129 connected to a network 1130. The processor 1121 may be a central processing unit (CPU) or a semiconductor device configured to execute processing instructions stored in the memory 1123 or storage 1128. The memory 1123 and the storage 1128 may be a variety of types of volatile or non-volatile storage media. For example, the memory may include ROM 1124 or RAM 1125.

Accordingly, the embodiments may be implemented as methods implemented by a computer or non-transient computer-readable media on which computer-executable instructions have been stored. When the computer-executable instructions are executed by a processor, the computer-readable instructions may perform a method according to at least one aspect of the embodiments.

As described above, in an embodiment, there are provided a method and apparatus for generating knowledge information related to the intake of a food using food information and the personal information of a user.

In an embodiment, there are provided a method and apparatus for providing an early warning for a food to be ingested by a user.

In an embodiment, a warning can be provided to a user with respect to a food including a food material that is prohibited from being ingested or whose amount of intake is limited a day for a reason, such as a disease.

In an embodiment, if a user prefers or does not prefer the attribute of a specific food, information about whether the food complies with a taste of the user can be provided.

In an embodiment, information about food may be provided to a user who aims to control the daily amount of intake of a specific ingredient of food in accordance with his or her target.

In an embodiment, a food provider can provide accurate food information about food, and users can safely ingest food whose food information has been provided.

Although the specific embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. A method of providing food information, the method comprising:
by a server:
receiving a request for knowledge information related to intake of a food of a user of a terminal from the terminal, wherein the request comprises a food identifier of the food and personal information of the user;
generating notification data, including the knowledge information, using food information, indicated by the food identifier, and the personal information; and
sending the notification data to the terminal.

2. The method of claim 1, wherein the knowledge information is indicative of a problem with the intake of the food of the user.

3. The method of claim 1, wherein the knowledge information is indicative of whether the food comprises an ingredient that causes an allergic reaction within the user indicated by the personal information.

4. The method of claim 1, wherein the knowledge information is indicative of achievement status of an intake target of the ingredient of the food related to the personal information.

5. The method of claim 1, wherein the knowledge information is indicative of whether an attribute of the food complies with a taste of the user indicated by the personal information.

6. The method of claim 5, wherein the attribute comprises a place of origin of the food.

7. The method of claim 1, wherein the server searches a knowledge base of the server for the knowledge information corresponding to the food information and the personal information using the food information and the personal information.

8. The method of claim 1, wherein the server generates the knowledge information through reasoning based on a food history of the food and the personal information.

9. The method of claim 8, wherein the food history comprises at least one of a production history of the food, a distribution history of the food, and a sales history of the food.

10. The method of claim 8, wherein the server converts the generated knowledge information into a form that is able to be added to the knowledge base, and adds the converted knowledge information to the knowledge base.

11. The method of claim 1, wherein the personal information comprises a search condition indicative of information that is related to the food and that is required by the user.

12. The method of claim 11, wherein the search condition is generated by converting a personal condition, including content that infringes upon the privacy of the user, into content that does not violate privacy.

13. The method of claim 1, further comprising receiving the knowledge information from food information storage managed by a provider of the food.

14. A server, comprising:
a communication unit configured to receive a request for knowledge information related to intake of a food of a user of a terminal from the terminal and to send notification data to the terminal, wherein the request comprises a food identifier of the food and personal information of the user; and
a processing unit configured to generate the notification data, including the knowledge information, using food information, indicated by the food identifier, and the personal information.

15. A terminal, comprising:
a communication unit configured to send a request for knowledge information related to intake of a food of a user of the terminal to a server and to receive notification data, including the knowledge information, from the server, wherein the request comprises a food identifier of the food and personal information of the user; and
an output unit configured to output a message indicative of the knowledge information;
wherein the knowledge information is generated based on food information, indicated by the food identifier, and the personal information.

16. The terminal of claim 15, further comprising a processing unit configured to convert the personal information into a search condition related to an attribute of the food if the personal information comprises content that infringes upon privacy.

17. The terminal of claim 16, wherein if the personal information is indicative of a disease of the user, the processing unit specifies a food material or ingredient related to the disease, and converts the personal information into a search condition that queries whether the food indicated by the food identifier comprises the specific food material or ingredient.

18. The terminal of claim 16, wherein the processing unit converts the knowledge information into content related to the privacy of the user.

19. The terminal of claim 16, wherein if the personal information is indicative of an intake target of a specific ingredient, the processing unit converts the personal information into a search condition that queries an amount of the ingredient.

20. The terminal of claim 15, further comprising a sensor configured to recognize the food identifier.
